(19) United States
(12) Patent Application Publication
(10) Pub. No.: US 2014/0091208 A1
(43) Pub. Date: Apr. 3, 2014

(54) OPTICAL MEASURING APPARATUS AND OPTICAL MEASURING MICROCHIP

(71) Applicant: SONY CORPORATION, TOKYO (JP)

(72) Inventor: Shinichi Kai, Kanagawa (JP)

(73) Assignee: SONY CORPORATION, TOKYO (JP)

(21) Appl. No.: 14/036,855

(22) Filed: Sep. 25, 2013

(30) Foreign Application Priority Data
Oct. 1, 2012 (JP) 2012-219166

(51) Int. Cl. G01N 21/01

(52) U.S. Cl. CPC G01N 21/01
USPC 250/214 C

(57) ABSTRACT

There is provided an optical measuring apparatus including a control unit that compensates detection light generated from a reaction area in a microchip, based on optical information from a detection-light-quantity calibration area.

### CROSS REFERENCES TO RELATED APPLICATIONS

The present application claims priority to Japanese Priority Patent Application JP 2012-219166 filed in the Japan Patent Office on Oct. 1, 2012, the entire content of which is hereby incorporated by reference.

### BACKGROUND

The present application relates to an optical measuring apparatus and an optical measuring microchip.

In recent years, technical researches on genetic analysis, protein analysis, cell analysis and the like, have been advanced in various fields such as the medical field, the drug development field, the clinical assay field, the food field, the agricultural field, and the industrial field. Most recently, there have been advanced technological developments and practical applications of lab-on-a-chip, in which various reactions, such as detections and analyses of nucleic acids, proteins, cells, or the like, are performed in a micro-scale flow passage or well provided in a chip. These have attracted attention as a technique for easily measuring biomolecules or the like.

On this occasion, for example, a method utilizing a nucleic acid amplification reaction by the PCR method, by which DNA fragments are amplified hundreds of thousands-fold, is typically used, in order to detect and measure even a slight amount of sample.

Furthermore, there are being developed optical analyzing apparatuses that detect and measure many samples by light absorption, fluorescence or luminescence using a microplate with many wells, even if the samples contain only a small amount of objective substance.

In recent years, optical analyzing apparatuses in which light-emitting diodes (LEDs) or semiconductor lasers are used as light sources instead of tungsten-halogen lamps or discharge tubes, have become the mainstream.

Also, there is known an absorptiometer that includes an irradiation mechanism to directly irradiate a specimen with light from a light-emitting diode (for example, see Japanese patent Laid-Open No. 9-264845). The second embodiment therein is configured to include plural LEDs and plural photodetectors that are respectively paired with the LEDs, corresponding to a matrix arrangement of plural measurement sites of a subject.

In addition, there are a beam scanning method in which irradiation light is shifted by an optical system, and a stage scanning method in which a stand carrying samples is moved. Furthermore, there in known a scanning detector that measures samples in a cartridge having reaction fields for nucleic acid amplification, and in which a column structure is used and incorporated into the mechanism along with a light source and a detection unit (for example, see National Publication of International Patent Application No. 2009-515162).

### SUMMARY

In the present application, it is desirable to provide an optical measuring apparatus that shows good detection accuracy, and an optical measuring microchip that allows for good detection accuracy.

According to an embodiment of the present application, there is provided an optical measuring apparatus including, a control unit compensating detection light generated from a reaction area in a microchip, based on optical information from a detection-light-quantity calibration area. The detection-light-quantity calibration area may be provided at an exterior and/or an interior of the microchip.

According to an embodiment of the present application, there is provided an optical measuring microchip. An adhesion layer having an ID area is formed. The ID area may contain assay information and/or chip information.

In accordance with the present application, it is possible to provide an optical measuring apparatus that shows good detection accuracy, and an optical measuring microchip that allows for good detection accuracy.

Additional features and advantages are described herein, and will be apparent from the following Detailed Description and the figures.

### BRIEF DESCRIPTION OF THE FIGURES

FIG. 1 is a diagram showing an optical measuring apparatus 1 according to a first embodiment of the present application;

FIG. 2 are schematic diagrams showing a detection optical system 7 of the optical measuring apparatus 1 according to the embodiment of the present application;

FIG. 3 is a diagram showing a relation between positions of the detection optical system and signal quantities (detection light) for reaction areas 4;

FIG. 4 is a diagram showing a relation between distances from an objective lens to a reaction area and signal quantities (detection light) for the reaction areas 4;

FIG. 5 is a diagram showing an example of an abnormal state of the movable detection optical system 7 of the optical measuring apparatus 1 according to the embodiment of the present application;

FIG. 6 is a diagram showing an example of a relation between positions of the movable detection optical system and signal quantities (detection light) for the reaction areas 4, when the movable detection optical system 7 is in an abnormal state;

FIG. 7 is a diagram showing a relation between positions of the detection optical system and signal quantities (detection light) for detection-light-quantity calibration areas 2 and the reaction areas 4;

FIG. 8 is a diagram showing an example of a relation between positions of the movable detection optical system 7 and signal quantities (detection light) for the detection-light-quantity calibration areas 2 and the reaction areas 4, when the movable detection optical system 7 is in an abnormal state;

FIG. 9A is a diagram showing an optical measuring apparatus 1 according to a second embodiment of the present application;

FIG. 9B is a diagram showing a relation between positions of the detection optical system and signal quantities (detection light) for the detection-light-quantity calibration areas 2;

FIGS. 10A and 10B are diagrams showing examples of a microchip having an ID area 33 according to an embodiment of the present application, where FIG. 10A shows an example in which a plurality of the ID areas 33 can be used as the detection-light-quantity calibration areas 2;

FIG. 11 is a diagram showing a microchip according to an embodiment of the present application, which has an ID area 33 formed by the presence or absence of an adhesion layer (by adhesives 331 and spaces 332);

FIG. 12 is a diagram showing the optical measuring apparatus and the microchip having the ID area 33 according to the embodiment of the present application, which is an example of a relation between positions of the detection optical system and signal quantities (detection light) for the ID area 33 and the reaction areas 4 in the case of the movable detection optical system 7; and

FIG. 13 is a flow diagram showing a behavior of the optical measuring apparatus, which is based on assay information and/or chip information contained in the ID area 33 of the microchip according to the embodiment of the present application.

### DETAILED DESCRIPTION

Hereinafter, preferred embodiments of the present disclosure will be described in detail with reference to the appended drawings. Here, embodiments described hereinafter are examples of representative embodiments of the present application, and the scope of the present application should not be narrowly interpreted by them.

### 1. Optical Measuring Apparatus 1 According to an Embodiment of the Present Application

(1) Detection-light-quantity calibration area 2

(2) Control unit

(3) Detection optical system 7

(4) Light source unit 5

(5) Detection unit 6

(6) Optical measuring microchip 3

### 2. Behavior of an Optical Measuring Apparatus 1 According to an Embodiment of the Present Application

(1) Behavior of an Optical Measuring Apparatus 1 with an ID Area

1. Optical Measuring Apparatus 1 According to an Embodiment of the Present Application

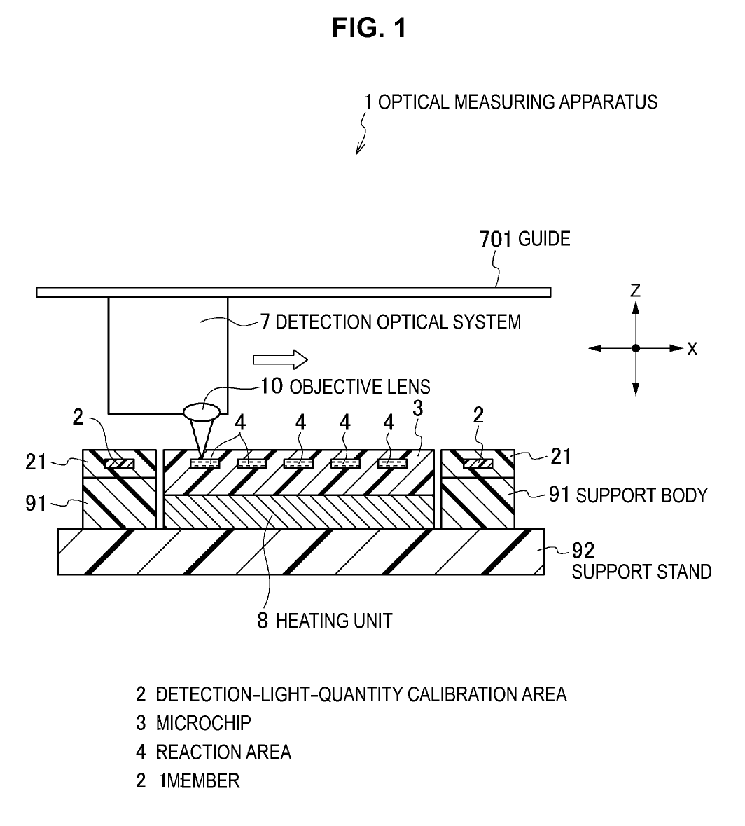

An optical measuring apparatus 1 (see FIG. 1) according to an embodiment of the present application includes a control unit (not shown) compensating the detection light generated from a reaction area 4 in a microchip 3, which is a field for various reactions, based on optical information from a detection-light-quantity calibration area 2.

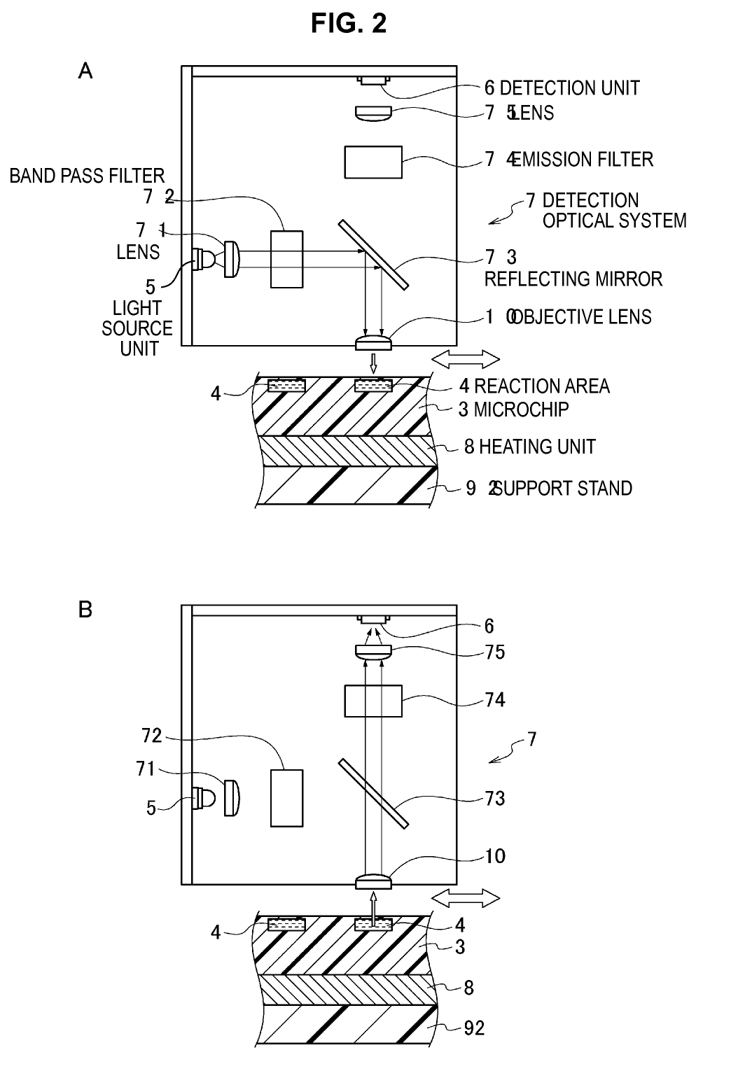

Preferably, the optical measuring apparatus 1 includes a light source unit 5 and a detection unit 6, furthermore include a detection optical system 7 that is configured to have the light source unit 5 and the detection unit 6 (see FIG. 2).

Preferably, the optical measuring apparatus 1 includes a heating unit 8 that controls reaction heat in the reaction area.

Preferably, the optical measuring apparatus 1 includes a support 9 (for example, a support body 91 and a support stand 92) that supports the detection-light-quantity calibration area 2, the microchip 3 and the like.

(1) Detection-Light-Quantity Calibration Area 2

The optical measuring apparatus 1 includes a single or plurality of the detection-light-quantity calibration areas 2.

Preferably, the detection-light-quantity calibration area 2 is provided at the exterior and/or the interior of the microchip 3. A case of being provided at the interior of the microchip 3 will be described later.

The detection-light-quantity calibration area (hereinafter, also referred to as “calibration area”) 2 can generate optical information that is a basis for calibration of the detection light from the reaction area 4.

In the present application, the calibration area 2 can be provided at the exterior of the microchip 3 and within the optical measuring apparatus 1. The calibration area 2 may be detachable. In the case of being detachable, the calibration area 2 can be appropriately exchanged corresponding to measuring objects.

Preferably, the calibration area 2 is arranged at a position where at least the calibration area 2 can face an objective lens 10 that can receive the detection light from the calibration area 2. Furthermore, preferably, the calibration area 2 is arranged at a position where the calibration area 2 can face the objective lens 10 by which the emitting light from the light source unit 5 is sent to the calibration area 2.

Preferably, the calibration area 2 is supported by the support body 91. A member 21 for providing the single or plurality of calibration areas 2 may be disposed on the support body 91. Furthermore, preferably, the member 21 is a movable member such as a slide member or a rotary member, by which the calibration area 2 can be moved. Thereby, the calibration area 2 can be easily exchanged corresponding to measuring objects. In the case of the plurality of the calibration areas 2, an exchange of them can be performed more easily.

More preferably, the single or plurality of calibration areas 2 is arranged at both sides or one side in the X direction and/or Y direction of the single or plurality of reaction areas 4 in the microchip 3. Furthermore, preferably, the calibration area 2 is arranged in the X direction in series with the reaction area 4. In addition, preferably, the plurality of calibration areas 2 are arranged at both sides of the reaction area 4.

Preferably, the plurality of calibration areas 2 are arranged on a plane or sterically. Here, to be arranged “on a plane” means that they are arranged in the X direction and/or Y direction, and to be arranged “sterically” means that they are arranged also in the Z direction, additionally.

The arrangement of the plurality of calibration areas allows for a calculation of a more highly accurate compensation value, by defining at least one calibration area 2 as a basis and comparing this basis and the others (detection area, reaction area or the like). Also, the arrangement of the plurality of calibration areas 2 allows for a calculation of a more highly accurate compensation value, when the single or plurality of reaction areas 4 are measured at the same period or at different periods.

In the case of the apparatus with the movable detection optical system, it is preferable that at least two calibration areas 2, 2 be provided at both sides of a row or column of the reaction areas 4. This simplifies the compensation easily, by scanning.

Preferably, the calibration area 2 contains a calibration substance. The calibration substance allows for generation of optical information that is a criterion in calibration of the detection light from the reaction area 4.

Preferably, the calibration substance is a substance that emits a desired light component and light quantity, and moreover, preferably the calibration substance is a substance that can correspond to the detection light generated from the reaction area (for example, a substance having an identical or similar wavelength region to the detection light). Furthermore, it is preferable to select a calibration substance that emits the detection light with a peak wavelength that is hardly influenced by a wavelength generated from a substrate forming the calibration area.

Examples of the calibration substance include a fluorescent substance, a chemoluminescence substance and a turbidity substance, and the calibration substance may be either an inorganic substance or an organic substance.

The calibration substance may be a layer that is composed of a substance yielding fluorescence and has an uneven thickness (for example, an adhesion layer).

Although the detection-light-quantity calibration substance may be in a solid form, in a semisolid form, or in a liquid form, it is preferable to be in a solid form because of allowing for prolonged stable use.

In the case where the calibration substance is a fluorescent substance, examples thereof include one or more inorganic substances selected from ruby, fluorite and the like that yield fluorescence by irradiation with excitation light; and one or more organic substances selected from plastic film and the like.

In the case where the calibration substance is an adhesion layer, preferably, an adhesive used in the adhesion layer contains a substance having a substance yielding fluorescence.

Examples of the adhesive include an inorganic adhesive, an organic adhesive and a natural adhesive. Among them, an organic synthetic adhesive is preferable. Examples of the synthetic adhesive include one or more adhesives selected from the group consisting of acrylcrylic resin, o-olefin, urethane resin, ethylene-vinyl acetate resin, epoxy resin, vinyl chloride, chloroprene rubber, vinyl acetate, cyanoacrylate, silicone, and nitrile adhesives. Among them, an adhesive used for adhesion of a microchip or the like, specifically, an acrylcrylic resin adhesive is preferable.

Preferably, the calibration substance is at the same position in the focus direction as the reaction area and a flow passage in the microchip. Furthermore, in order to equalize optical properties such as transmittance and spherical aberration with the well and the flow passage, it is preferable that the upper portion of the calibration substance is covered with the same material as the material of the upper portion of the reaction area 4.

(2) Control Unit

The control unit according to the embodiment of the present application compensates the detection light generated from the reaction area 4 in the microchip 3, based on the optical information from the single or plurality of calibration areas 2.

The reaction area is non-limiting if it is an area where desired detection light can be detected in the microchip. Examples thereof include a well and a flow passage.

It is possible that a behavior, compensation method, determination method and procedure in the apparatus according to the embodiment of the present application are stored as programs in hardware resources that have a control unit including a CPU, a RAM, a ROM and the like, a recording medium (for example, USB memory, HDD and CD) and others, and then the programs are executed by the control unit or the like.

The control unit controls the light source unit 5 such that the light source unit 5 irradiates the calibration area 2 with predetermined light. Then, the control unit controls the detection unit 6 such that the detection unit 6 detects the detection light generated from the calibration area 2 as the optical information.

Furthermore, the control unit controls the light source unit 5 and the detection unit 6 so as to irradiate the reaction area 4 in the microchip 3 with predetermined light, and detect the detection light generated therefrom.

Also, the control unit can perform various controls in the optical measuring apparatus (for example, a control relevant to reaction conditions). Examples thereof include a control of the heating unit depending on a reaction temperature and reaction time for a measuring object as reactions condition, a control of driving of the detection optical system if it is movable, and a processing of various calculations.

The control unit compensates the detection light generated from the reaction area 4, based on the optical information that is obtained from the plurality of calibration areas 2 arranged on a plane or sterically. Use of the plurality of calibration areas allows for a calculation of a more highly accurate compensation value, by defining one of them as a basis and comparing it with the others.

Preferably, the control unit compensates the detection light from the reaction area, based on a first distance (signal) between the calibration area 2 and the detection optical system 7, and a second distance (signal) between the reaction area 4 and the detection optical system 7. The first distance (signal) is based on the optical information.

On this occasion, preferably, the control unit compensates the detection light from the reaction area, based on the plurality of pieces of optical information that are obtained from the plurality of calibration areas 2 having a planar positional relation in the X direction and/or Y direction.

Here, the “first distance” is a distance in the Z direction between the detection optical system (for example, the objective lens) and the calibration area. The “second distance” is a distance in the Z direction between the detection optical system (for example, the objective lens) and the reaction area. The Z direction is also the focus direction.

Examples of a starting point or ending point when determining a distance in the focus direction (the Z direction) include, but are not limited to, the detection unit 6 and the objective lens 10, which are disposed in the detection optical system 7.

Preferably, the control unit compensates the detection light, based on a planar (X direction and/or Y direction) distance between the calibration area 2 and the reaction area 4.

Preferably, the control unit compensates the detection light generated from the reaction area 4 in the microchip 3, based on the optical information obtained from the plurality of calibration areas 2 that are sterically arranged in a stair-like manner.

Also, the control unit can perform something relating to controls of the components of the optical measuring apparatus 1 according to the embodiment of the present application, such as a heat control of the heating unit 8 that heats the reaction area 4, and a motion control of the movable detection optical system 7 that acquires the optical information.

For example, in the case where the detection optical system 7 is movable and has a motion mechanism (a guide mechanism, a rack and pinion mechanism, or the like), the control unit enables the detection optical system 7 to move over the microchip and scan a measuring object.

Then, based on the optical information transmitted from the movable detection optical system, the control unit calculates a first signal quantity that is estimated from the optical information from the plurality of detection-light-quantity calibration areas. Furthermore, the control unit calculates a second signal quantity that is calculated from the acquired optical information. Also, it is possible to determine a state of the movable detection optical system (normal state or abnormal state), by comparing the first signal quantity and the second signal quantity.

Furthermore, it is preferable to compensate the detection light, based on a relation of the first distance between the detection-light-quantity calibration area 2 and the detection optical system 7, which is based on the optical information, with the second distance between the reaction area 4 and the detection optical system 7.

Furthermore, it is preferable to compensate the detection light, based on the relation of the first distance with the second distance, and a relation with the planar distance between the detection-light-quantity calibration area and the reaction area.

In addition, it is preferable to sterically provide the plurality of detection-light-quantity calibration areas and compensate the detection light generated from the reaction area in the microchip, based on the plurality of pieces of optical information from the detection-light-quantity calibration areas.

With reference to FIGS. 1 to 5, a method for compensating the detection light generated from the reaction area 4 in the microchip 3 based on the optical information from the calibration area 2 will be described in more detail, by the optical measuring apparatus including the movable detection optical system.

The present application can be also applied to an optical measuring apparatus including a non-movable detection unit such as an array detector and a CCD detector.

A basic behavior of the movable detection optical system 7 when measuring the detection-light-quantity calibration area and reaction area using the scanning-type optical measuring apparatus according to the embodiment of the present application shown in FIGS. 1 to 5, will be described with reference to FIG. 2 and others.

The control unit of the scanning-type optical measuring apparatus emits light from the light source unit 5 (for example, an LED) in the movable detection optical system 7. The emitting light is beamed through a lens 71 and a band pass filter 72 to a reflecting minor (a beam splitter) 73, and thereby is beamed from the objective lens 10 to the detection-light-quantity calibration area 2 in the microchip 3, so that the detection light is radiated from the calibration area 2. This detection light is collected by the objective lens 10 and passes through the reflecting minor 73. The detection light with a particular wavelength passes through an emission filter 74, and its light quantity is detected by a photodetector in the detection optical system 7 (see FIG. 2). The detected quantity is called a signal quantity. The control unit scans the reaction area 4 and the calibration area 2 and detects each detection light (signal quantity), using the movable detection optical system 7.

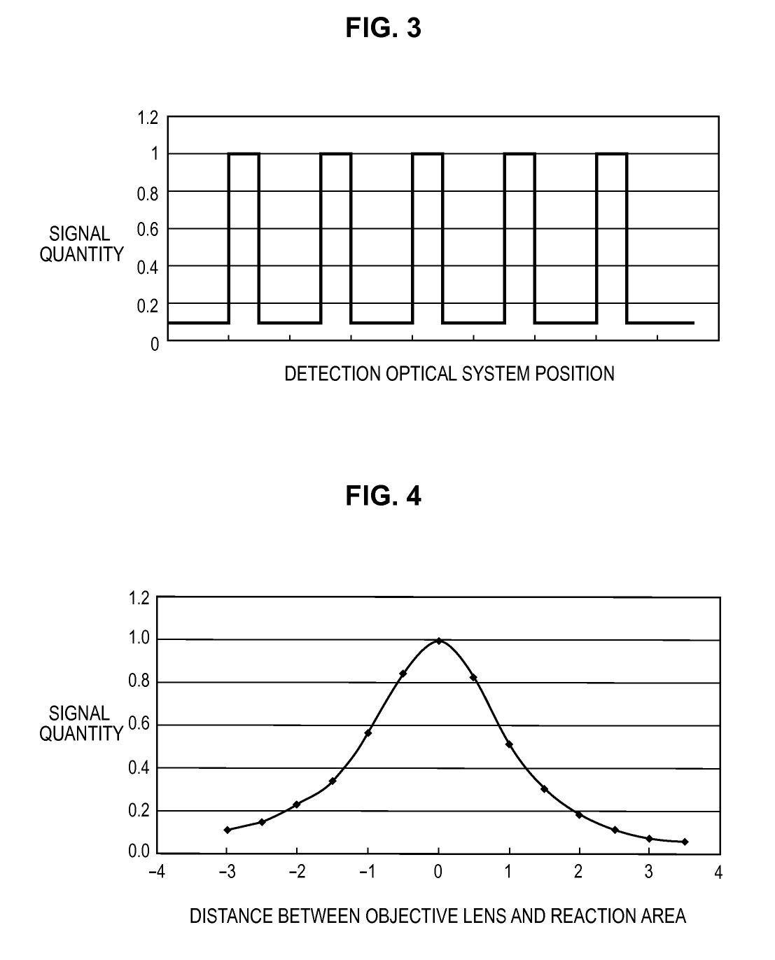

A method for compensating the detection light from the reaction area according to the embodiment of the present application will be described in more detail with reference to FIGS. 3 to 8, but the present application is not limited to this.

FIG. 3 shows an example of signals when the detection optical system 7 in a normal state detects the detection light (fluorescence or the like) radiated from the reaction areas 4 that contain the same reagent and sample at the same concentration. In this case, the same quantity of detection light (fluorescence quantity or the like) is radiated from all the reaction areas 4. The movable detection optical system 7 moves over the microchip 3 and scans the reaction area 4, and when the center of the objective lens 10 is just above the reaction area 4, the detected signal increases.

FIG. 4 shows the signal quantity detected from the reaction area 4 by the detection optical system in the case of changing a distance between the detection optical system 7 and the reaction area 4. The “distance between objective lens and reaction area” indicates deviations from the optimal distance.

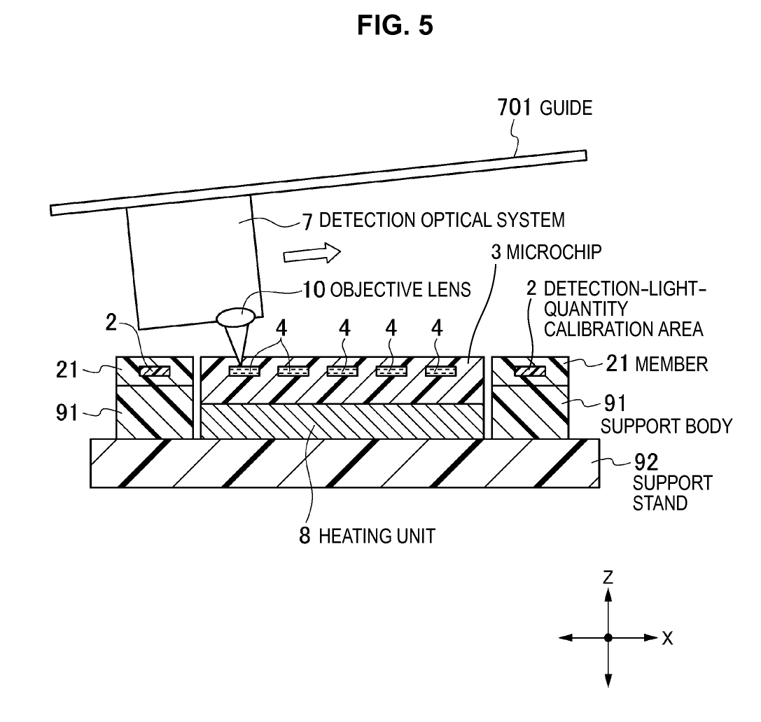

In FIG. 5, an attachment of the motion mechanism (guide mechanism or the like) of the movable detection optical system 7 in the optical measuring apparatus 1 according to the embodiment of the present application is mechanically incorrect, and thereby the distance between the objective lens and the reaction area varies for each reaction area.

In the case of FIG. 5, the “distance between objective lens and reaction area” deviates from the optimal value, and the “distance between objective lens and reaction area” becomes greater in proportion as the movable detection optical system 7 moves rightward. Thereby, as shown in FIG. 5, the signal quantities detected from the reaction areas 4 decrease in rightward order. Since the “distance between objective lens and reaction area” varies in this way, the signal quantity varies for each reaction area. Thus, unless the detection light is compensated, it may be difficult to accurately measure the detection light quantity (for example, fluorescence quantity) in the reaction area, and therefore, it may be difficult to accurately measure the quantity of a sample (for example, DNA etc.) or a time-dependent change.

In particular, in the case of judging the quantity of a sample (for example, DNA) on the basis of a certain threshold value, the traditional apparatus, in which the detection light is not compensated unlike the present application, is likely to incorrectly determine a change in signal quantity caused by a change in the apparatus side.

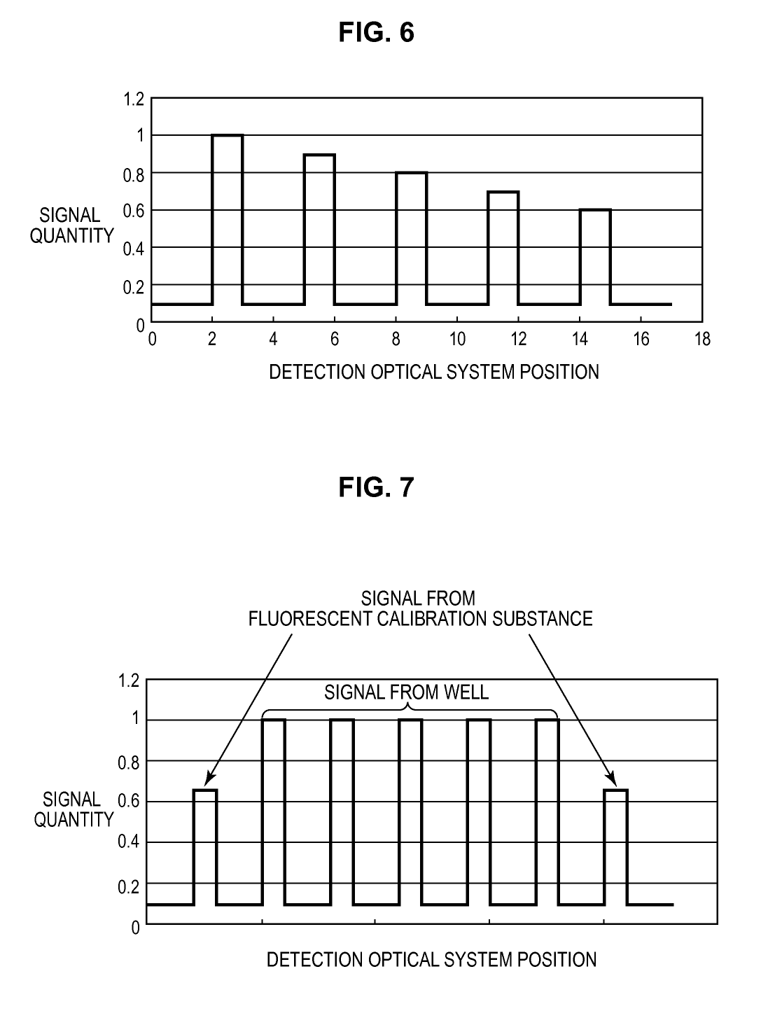

To explain in more detail, to the control unit of the apparatus, for example, a value of 0.7 is set as a predetermined threshold value, a value of 0.7 and more (threshold value and more) is set as positive (+), and a value of less than 0.7 is set as negative (−). FIG. 3 shows correct signal quantities when the apparatus is in a state with no defect and failure, and FIG. 6 shows incorrect signal quantities when the apparatus is in an abnormal state with a defect or the like.

In FIG. 6, the signal of the reaction area in the rightmost side, which would be determined as being positive if a measured detection result were correct (see FIG. 3), indicates 0.6, and therefore, a determination as being negative is made incorrectly.

Here, it is likely that a change in the “distance between objective lens and reaction area” is caused by, for example, the motion mechanism, or an incorrect setting of the microchip. Examples of causes relevant to the motion mechanism include a deviated attachment of a guide of the detection optical system, and a deviated attachment of the support body supporting the detection optical system. Examples of causes relevant to the microchip include a change in the elastic property of an elastic body (a spring or the like), which is disposed under the support body supporting the microchip.

Responding to this, by employing the present application, providing the calibration area 2, and providing the control unit that can execute the method in which the detection light generated from the reaction area 4 is compensated based on the optical information from the calibration area 2, it is possible to obtain a more highly accurate detection result.

A concrete example will be described below, but a processing method and determination method for compensating the detection light generated from the reaction area in the microchip based on the optical information from the calibration area is not limited to this.

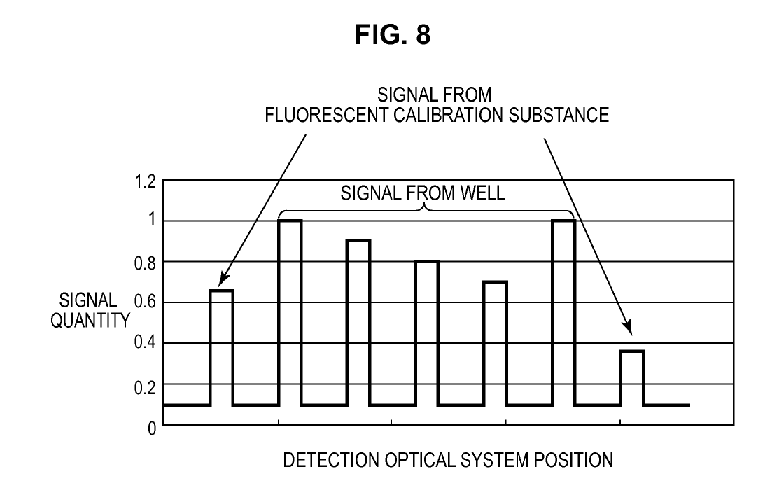

In the case where the reaction conditions such as a sample concentration are the same among the reaction areas, it is possible to obtain signal quantities of the calibration areas and reaction areas shown in FIGS. 7 and 8.

As shown in FIG. 7, when the movable detection optical system 7 is in a normal state in which the “distance between objective lens and reaction area” in the optical measuring apparatus does not change, the signal quantities from the two calibration areas 2 are the same. Since the signal quantities are the same in this way, the control unit according to the embodiment of the present application determines that the movable detection optical system 7 is in a normal state.

On the other hand, when the movable detection optical system 7 is in an abnormal state in which the “distance between objective lens and reaction area” changes, the signal quantities from the two calibration areas 2 are different from each other. Since the signal quantities are different in this way, the control unit according to the embodiment of the present application determines that the movable detection optical system 7 is in an abnormal state. Then, the control unit according to the embodiment of the present application determines that a calibration of the detection light from the reaction area 4 is desirable.

In the control unit according to the embodiment of the present application, in the case of a normal state, the signal quantities from the two calibration areas 2 is the same. On the other hand, in the case of an abnormal state, the signal quantities from the two calibration areas 2, which are originally the same, are shown differently. By using the difference between these signal quantities, a calibration (compensation) of the detection light from the reaction area 4 is performed.

The control unit according to the embodiment of the present application calculates a distance as a signal quantity between the reaction area 4 and the movable detection optical system 7 (preferably, the detection unit 6) that detects the detection light from the reaction area. Then, the control unit compensates the detection light using the difference between the signal quantity and a signal quantity based on the optical information from the calibration area 2.

Concretely, the control unit according to the embodiment of the present application makes data shown in FIG. 8 based on the signal quantities and positions of the detection optical system, depending on distances from the reaction areas 4 and the two calibration areas 2 (distances in the X direction and/or Y direction). The signal quantities from the reaction areas 4 are compensated based on the optical information from the calibration areas 2.

For example, in FIG. 8, using the position and signal quantity of the left calibration area as a basis, the signal quantity therefrom is defined as S1, the distance to the right calibration area is defined as L1, the signal quantity from the right calibration area is defined as Sr, the distance to the i-th reaction area is defined as Li, and the signal quantity from the i-th reaction area is defined as Si.

On this occasion, the planar arrangement of the calibration areas may be previously set to the control unit, be input, or be contained in the optical information of an ID area or the like. Also, it is allowable that the control unit determines as a planar arrangement when the calibration areas are arranged at the first and last positions for the measurement.

Thereby, the after-compensation signal quantity from the i-th reaction area, Si_comp, can be calculated from Si_comp=Si*(S1/Sr)*(Li/L1).

In order to determine the absolute value of the “distance between objective lens and reaction area” more accurately, it is preferable to form a detection-light-quantity calibration area group 20 that includes a plurality of the calibration areas 2 whose heights are slightly different in the focus direction (the Z direction). On this occasion, the steric arrangement of the calibration areas may be previously set to the control unit, be input by an operator, or be contained in the optical information of the ID area or the like. Also, it is allowable that the control unit determines as a steric arrangement when the plurality of calibration areas are serially arranged in the X direction and/or Y direction.

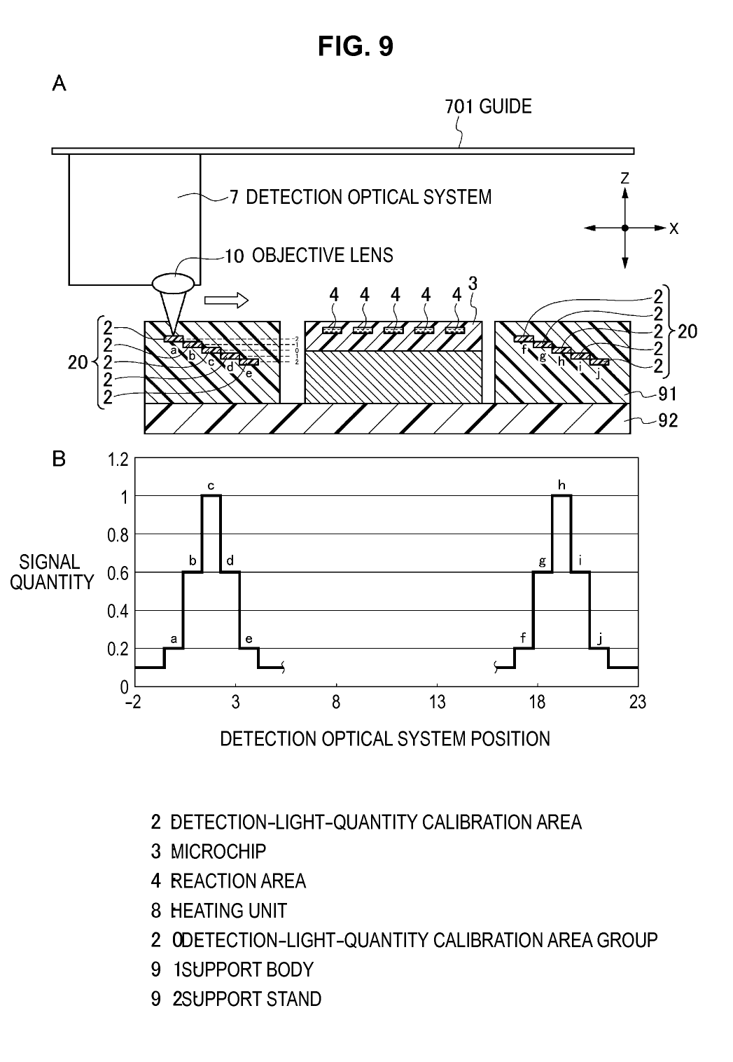

As shown in FIG. 9, in a group of the plurality of detection-light-quantity calibration areas arranged sterically, the plurality of detection-light-quantity calibration areas 2, 2, 2, . . . are provided with different heights in the Z direction in a stair-like manner. Preferably, the calibration areas 2 are provided with different heights in the Z direction in a stair-like manner such that distances in the focus direction become larger in the moving direction of the movable detection optical system 7.

Furthermore, preferably, a group of the plurality of calibration areas 2, 2, 2, . . . whose heights are slightly different in the focus direction (the Z direction) is provided at both ends of the reaction areas 4.

More concretely, in the calibration area group 20, the plurality of calibration areas 2 are serially arranged in the X direction and/or Y direction with different heights in the Z direction. In the case of the movable detection optical system, it is preferable to be the calibration area group 20 in which the calibration areas 2 are serially arranged in the X direction and/or Y direction with different heights.

Concretely, the calibration area group 20, which is a group of the calibration areas 2, has a configuration in which the calibration areas with heights (the Z direction) differing by 0.5 are arranged at distances corresponding to −2 to 2 in the “distance between objective lens and reaction area”. When detecting the detection light from the detection-light-quantity calibration areas 2, 2, 2, . . . with the movable detection optical system 7, the signals shown in FIG. 9B (single-peaked pattern with a bilaterally symmetric shape) is obtained. In FIG. 9A, the signal from the left group shows the peak at the detection-light-quantity calibration area c, and the signal from the right group shows the peak at the detection-light-quantity calibration area h. Thereby, the control unit according to the embodiment of the present application determines that the positions of the detection-light-quantity calibration areas c and h are basis distances in the “distance between objective lens and reaction area” for the detection light from each reaction area 4, and stores this. Then, by this storing, the control unit according to the embodiment of the present application compensates the signal quantities from the reaction areas 4, based on the optical information from the detection-light-quantity calibration area group 20. Thereby, it is possible to compensate the detection light from the reaction area more accurately.

When the movable detection optical system is in an abnormal state, the detection light from the calibration areas is shown in a bilaterally asymmetric shape. In such a case, the detection light from the calibration area group is compensated such that the calibration area group has a single-peaked pattern with a bilaterally symmetric shape, and then, based on the shape (optical information) in this group, it is possible to compensate the detection light from the reaction area. Furthermore, it is possible to compensate the detection light from the calibration areas by comparing the calibration areas with the same height, such as the calibration areas c and h, and to compensate the detection light from the reaction area based on the compensated optical information.

In accordance with the above-described example of the group of calibration areas, the control unit according to the embodiment of the present application can measure the signal quantity from the calibration area 2 at the basis position in the “distance between objective lens and reaction area”. Thereby, the control unit according to the embodiment of the present application can find and determine a change of the movable detection optical system easily and accurately.

Therefore, it is possible to compensate the detection light from the reaction area 4, based on the information that is previously stored in the control unit of the optical measuring apparatus according to the embodiment of the present application after measuring the above-described signal.

Then, in measurement by a user, the control unit according to the embodiment of the present application can compare the peak values between the detection light (signal quantities) from the reaction areas 4 and the stored signal quantities. By this comparison, the control unit according to the embodiment of the present application can find and determine a change of the detection optical system caused by a change in excitation-light quantity or a change in transmittance of the detection optical system.

Furthermore, it is possible to use the optical measuring apparatus for a positive/negative determination. On this occasion, the control unit according to the embodiment of the present application can change a threshold value for a positive/negative determination as well as the signal quantity from the reaction area 4 described above, depending on a determination based on the optical information from the calibration area 2. Thereby, the control unit according to the embodiment of the present application can compensate a changed portion by the movable detection optical system more accurately.

(3) Detection Optical System 7

The detection optical system 7 includes the light source unit 5 and the detection unit 6. As appropriately, various desired filters, lenses, mirrors and the like are provided.

In the present application, it is preferable that the light source unit 5 and the detection unit 6 constitute the detection optical system 7 with a motion mechanism 701 (hereinafter, also referred to as “movable detection optical system”). The movable detection optical system 7 is subject to a problem that the detection system moves in the X direction, the Y direction or the like, and an inclination or deviation of the detection system occurs by an external vibration or impact. However, employing the present application allows for an accurate detection.

(4) Light Source Unit 5

As for the number of the light source unit 5, there may be either a single light source unit or a plurality of light source units. An emission timing and output (excitation-light wavelength, light quantity or the like) of the single or plurality of light source units 5 may be controlled by the control unit.

Examples of the light source unit 5 include a laser source, a light-emitting diode (LED) light source, a mercury lamp and a tungsten lamp. These may be used alone or in combination of a plurality of them.

In the case of a laser lamp, because of its narrow spectrum width and high output power, it is possible to exclude an excitation filter (Ex. filter) that is traditionally desirable.

Examples of an LED light source include red, orange, yellow, green, blue, white and ultraviolet LED light sources, and these may be used alone or in combination of a plurality of them. Examples of a multicolor LED light source include a three-color LED light source and a four-color LED light source. These can produce desired excitation light by an excitation filter. Also, employing a light guide plate allows for a multicolor excitation by a plurality of LED light sources, and a time-sharing. In addition, a multicolor LED light source allows for not only a one-time excitation but also a sequential excitation without using a light guide plate.

(5) Detection Unit 6

Preferably, the detection unit 6 is disposed so as to detect light components (for example, transmitted light, fluorescence, and scattered light) that are generated from the reaction area 4.

Preferably, the detection unit 6 includes a light detector capable of detecting an intended light component (for example, a fluorescence detector, a turbidity detector, a scattered light detector, and an ultraviolet-visible spectrum detector). Examples of the detector include an area imaging element such as a CCD or CMOS element, a photomultiplier tube (PMT), a photodiode and a compact sensor.

A plurality of fluorescent dyes that are excited by different wavelengths in the reaction area emit fluorescence with different wavelengths, respectively. An efficient detection of these light components is achieved, for example, by being equipped with a multiband pass filter that has a transmission band corresponding to the plurality of fluorescence spectra. Then, it is possible to emit excitation light with a plurality of wavelengths in a time-sharing manner, and synchronously with the emission, detect the intensity of each fluorescence with the light detector.

As for the excitation filter, it is allowable to appropriately select a filter by which a desired light component with a specific wavelength can be obtained depending on various light analysis methods.

As for the detection filter, it is allowable to appropriately select a filter depending on a light component desirable for the detection (fluorescence, scattered light, transmitted light or the like).

In the optical measuring apparatus according to the embodiment of the present application, as appropriately, a single or plurality of the excitation filters and the detection filters may be included, and depending on circumstances, they may be excluded. By these filters, it is possible to obtain desirable light components and remove unnecessary light components. Thereby, it is possible to increase detection sensitivity and detection accuracy.

The optical measuring apparatus according to the embodiment of the present application may appropriately include a single or plurality of the heating units 8 (heaters or the like) performing a heat control of the reaction area, the lenses, the excitation filters, the detection filters and the supports 9 for supporting each unit and mounting the reaction area. The optical measuring apparatus 1 may include the control unit that controls an emission timing and output (excitation-light wavelength, light quantity or the like) of the excitation light, a time-sharing, a multicolor time-sharing and the like, and thereby may control the above-described units.

Examples of the heating unit include, but are not limited to, a transparent conductive film such as an optically transparent ITO heater.

(6) Optical Measuring Microchip 3

As for the microchip 3 used in the above-described optical measuring apparatus 1, in the case where the calibration area 2 is provided at the exterior, an ordinary microchip 3 may be used.

In the case where the calibration area 2 is provided at the interior, based on the calibration area 2 of the microchip according to the embodiment of the present application, it is possible to compensate the detection light from the reaction area.

In the case where the calibration area 2 is provided at the interior of the microchip, based on the calibration area 2 of the microchip according to the embodiment of the present application, it is possible to compensate the detection light from the reaction area. The calibration area 2 formed at the interior of the chip is described in the above “(1) Detection-light-quantity calibration area 2.”

Also, in the microchip 3 according to the embodiment of the present application, it is possible to make an ID area 33 at the adhesion layer 34 and use the ID area 33 as the calibration area 2. At the adhesion layer 34 having the ID area 33, there is provided a plurality of the calibration areas 2 for compensating the detection light generated from the reaction area that is a reaction field, as assay information and/or chip information.

In the ID area 33, it is possible to form a discrimination pattern by a thickness of the adhesion layer 34.

In the microchip 3 according to the embodiment of the present application, a single or plurality of ID area 33 portions are formed at the adhesion layer 34. Furthermore, the ID area 33 contains assay information and/or chip information. In addition, in the ID area 33, there is an area in which a discrimination pattern is formed by a thickness of the adhesion layer.

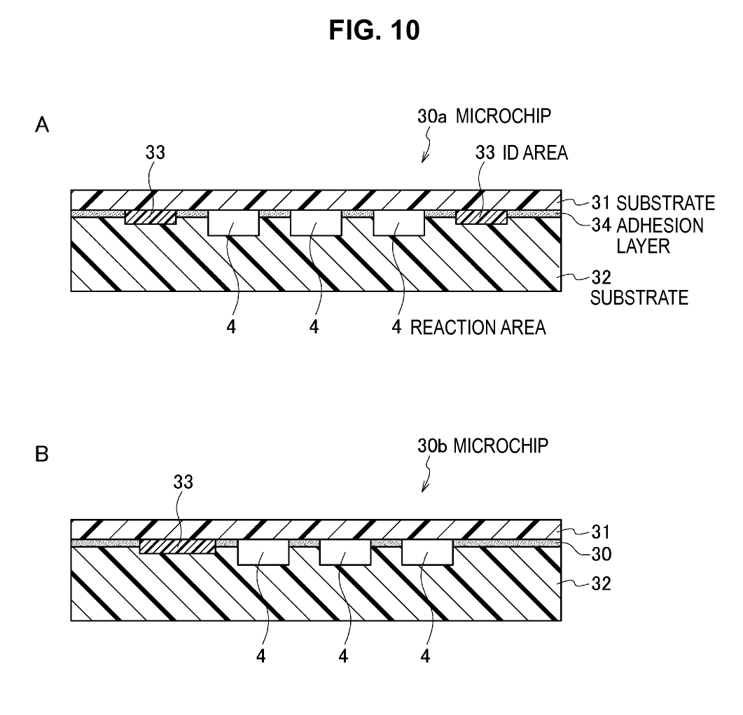

In the optical measuring microchip 30 according to the embodiment of the present application, a portion that is the ID area 33 is formed at the adhesion layer 34 of the substrate. Examples in the case of the single of ID area 33 include a microchip 30b shown in FIG. 10B, and examples in the case of the plurality of ID areas 33 include a microchip 30a shown in FIG. 10A.

A variety of information is stored and contained in the ID area 33, and examples of information include one or more selected from detection-light-quantity calibration information, assay information and chip information.

The detection-light-quantity calibration information is, for example, information by which the control unit of the optical measuring apparatus according to the embodiment of the present application compensates the detection light from the reaction area 4, and which is previously measured as signals by the apparatus and is stored. The detection-light-quantity calibration information for compensating the detection light from the reaction area 4 may be included in the assay information.

Examples of the assay information include information relevant to reaction conditions for a chemical reaction described later (fluorescent substance, reaction temperature and the like), and a calibration substance described above (emitting wavelength, calculation processing method and the like).

Examples of the chip information include information relevant to the material and durability of the microchip, and the thickness from the substrate surface to the reaction area or calibration area.

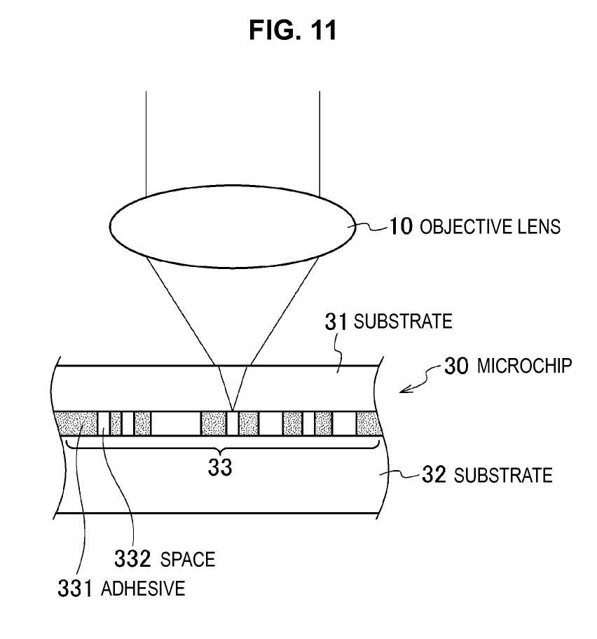

As shown in FIG. 11, an information acquiring unit (for example, the detection optical system) reads a variety of information described above, the information is transmitted to the apparatus, and based on the information, a setting or changing of conditions is performed for measurement.

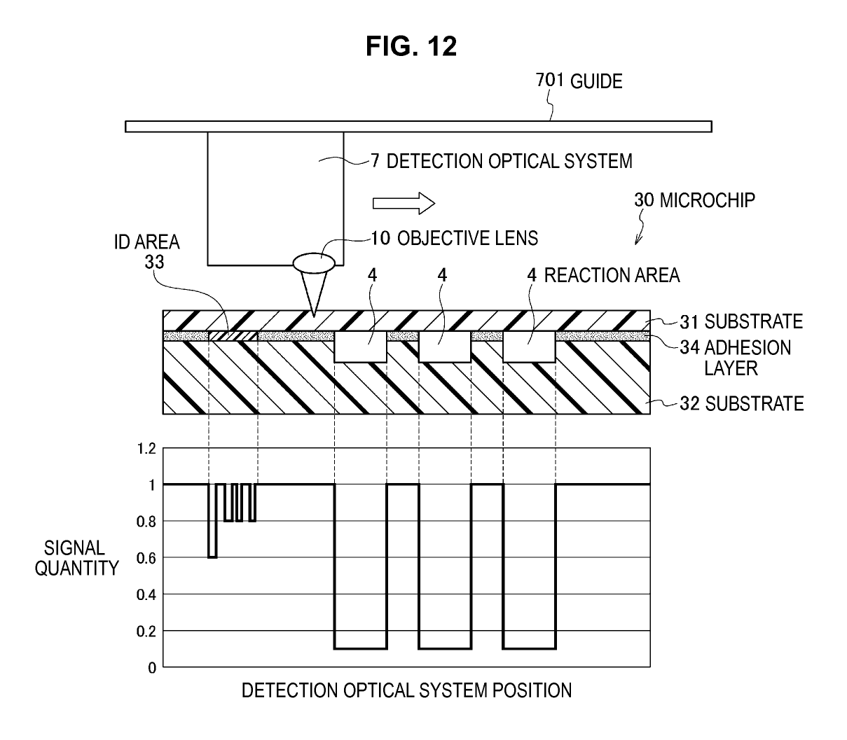

For example, to explain with reference to FIG. 12, by reading the ID area 33, a signal pattern (difference in height, difference in width, or the like) is acquired. Based on this signal pattern, the control unit according to the embodiment of the present application performs a matching with a signal pattern that is previously stored in a storage unit, and compensates the detection light from the reaction area 4. In the case of having the plurality of ID areas 33, it is possible to compensate the detection light from the reaction area 4, based on a result derived from a comparison between them.

For example, by reading information for a calibration substance, the material of the microchip, the thickness to the areas, and the like, it is possible to compensate the detection light generated from the reaction area 4 more accurately.

Furthermore, it is preferable that the ID area 33 be an area in which the discrimination pattern is formed by a thickness of the adhesion layer 34, and thereby, it is possible to store a wide range of information such as the optical information. When the discrimination pattern is formed in the area, it is possible to form it by intervals and thicknesses of potions with no adhesive, as shown in FIG. 11. Examples of a forming method include an ink-jet method, a printing method, and an etching method by a laser or the like.

The reaction area 4 is an area that is a reaction field for chemical reaction, and for example, is formed in a reaction container such as the microchip for chemical reaction.

The reaction area is formed in a single or plurality of reaction substrates. The reaction substrate can be formed by a wet etching or dry etching of a glass substrate layer, or by a nanoimprinting, injection molding or cutting of a plastic substrate layer. On this occasion, the shape of the reaction area can be appropriately set, and may be, for example, a well shape.

The material of the reaction substrate is non-limiting, and it is preferable to be appropriately selected in view of a detection method, easy processing, durability and the like. The material may be appropriately selected from optically transparent materials depending on a desired detection method, and examples of the material include glass, and various plastics (polypropylene, polycarbonate, cycloolefin polymer, polydimethylsiloxane and the like).

It is allowable to appropriately fill the reaction area with reagents desirable for nucleic acid amplification reaction when forming the reaction container.

The optical information (data) from the ID area 33 of the microchip according to the embodiment of the present application is transmitted through the detection optical system 7 to the control unit, and thereby the control unit can control behaviors of the units of the optical measuring apparatus.

An example of use of the optical measuring microchip according to the embodiment of the present application will be described below.

FIG. 12 shows a system that detects the fluorescence quantity from a well or flow passage of the microchip 30 according to the embodiment of the present application.

In this case, the microchip 30 is made from both upper and lower substrates 31 and 32, and the flow passage and well are formed in the lower substrate 32. The upper and lower substrates 31 and 32 are integrated by the adhesion layer 34 therebetween.

The adhesion layer 34 is not present in the flow passage or well. In this system, the detection optical system 7 scans the microchip 30, and thereby, as shown in a graph in the lower part of FIG. 12, it is possible to detect signals from the flow passages and wells.

This shows signal quantities in the case where samples are not present in the flow passages and wells. In the case where samples are present, the signal quantities increase.

The microchip 30 is irradiated with excitation light from the detection optical system 7. Thereby, at a portion (an adhesive 331) where the adhesion layer 34 is present, since the adhesion layer generates intrinsic fluorescence, the signal quantity detected by the detection optical system becomes large. At a position (a space 332) where the adhesion layer is not present, the signal quantity detected by the detection optical system becomes small. In the well or flow passage portion, the signal quantity is small because of the absence of the adhesion layer.

Then, by distinguishing these signals by largeness using a certain signal quantity as a threshold value, it is possible to determine the position of the well or flow passage before a sample treatment.

Since the signal quantity varies depending on the presence or absence of the adhesive and the amount of the adhesive, it is possible to provide the ID area in the microchip by the presence or absence of the adhesive and the amount of the adhesive, and hold the above-described assay information and/or chip information in the ID area.

In a scanning by an optical measuring apparatus in the related art, an operator inputs treatment conditions specific to each assay. Although the treatment conditions specific to each assay is important, it is highly likely to mistake a temperature setting or the number of temperature change cycles, which is a treatment condition specific to each assay, by human error. In that case, a biochemical treatment departs from an optimal condition, leading to an incorrect result. This can cause a serious matter if the system is used as a diagnostic apparatus.

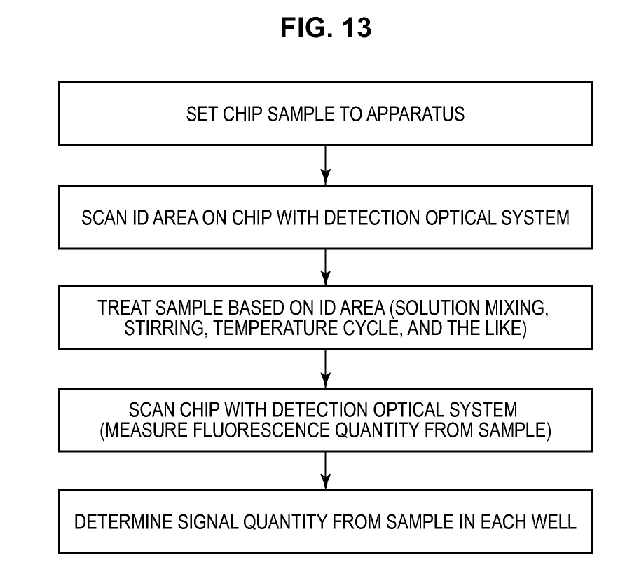

FIG. 13 shows a system according to an embodiment 1 of the present application.

(step S1) The microchip 30 is set to the optical measuring apparatus 1. It is allowable to be set by a user or automatically.

(step S2) After the microchip 30 is set, the detection optical system 7 scans the ID area 33 on the chip 3. Since the detection optical system 7 reads the ID area 33, it is possible to exactly know assay conditions desirable for the chip 3, and exactly set a temperature and the number of temperature cycles from the information.

As shown in FIGS. 10 to 12, the ID area 33 is provided at the adhesion layer 34 near the well or flow passage. In this ID area 33, the chip information and/or assay information used in the chip and the like are recorded and held.

(step S3) Thereafter, the control unit sets conditions specific to each assay, such as a mixing of a solution and a sample, and the number of temperature cycles, to the storage unit of the optical measuring apparatus 1. Then, the control unit starts a biochemical treatment (reaction) for the sample.

(step S4) After the reaction ends, the control unit makes the detection optical system 7 scan the chip 3 again and detect the detection light (signal quantity) from the treated sample in each well. Here, in the present application, it is possible to select a real-time measurement. In this case, the reaction area 4 is scanned continuously or discontinuously during the reaction.

A system according to an embodiment 2 of the present application will be described.

The embodiment has the same flow as the above-described embodiment 1 except that (step S2) in the above-described embodiment 1 is changed into (step S21).

(step S21) As shown in FIG. 12, the ID area 33 and the reaction areas 4 that are wells or flow passages are scanned. Based on this scanning, the control unit can detect the position of each well and the signal quantity in the initial state (when samples are not present in the wells), as the graph of the lower diagram in FIG. 12.

In step S21, the reaction area 4 is scanned along with the ID area. This scanning can be utilized as a blank, and, in a detecting, the areas of the well and flow passage can be exactly scanned for measurement. Thereby, it is possible to accurately detect the measuring object.

Here, as shown FIG. 11, a detection spot is typically designed such that the spot diameter is minimal at the position of the well or flow passage and is large at the upper portion of the chip.

As for a method for recording information in the ID area 33 according to the embodiment of the present application, signals are recorded using the presence or absence of the adhesion layer 34 between the upper and lower substrates. Preferably, these signals are digital signals as used in optical disk systems.

In the present application, since the adhesion layer 34 emits intrinsic fluorescence, the signal quantity detected by the detection optical system is large at a position where the adhesion layer 34 is present, and is small at a portion where the adhesion layer 34 is not present.

By using the largeness of the signal quantity as modulating signals, it is possible to record discrimination data of an assay of the chip 3 and chip information.

In the present application, since the microchip is intrinsically desired to include the adhesion layer, there is s great industrial advantage that the chip with the information can be produced at low cost just by performing a slight processing to the adhesion layer.

In related art, there has been used a method in which a discrimination bar code is attached to the outside of a chip, or a method in which a substance emitting intrinsic fluorescence is attached to an upper portion of a chip. However, the bar code or the like must be additionally attached to the chip, resulting in an increase in costs of producing the chip. In particular, the bar code requires a bar-code reading device separately besides the detection optical system, causing a complication of the apparatus and an increase in costs for the apparatus.

As related art, in the case of attaching a substance for ID to an upper portion of a chip, each single signal needs to be large. Because of this, there is a possibility that an area desirable for ID is enlarged, and the position detection of the well or flow passage is adversely affected. For example, there is a possibility that a portion emitting long signals in the ID area is judged as a well.

As another method for an ID recording, for example, there is a method in which mere uneven embossments are applied to the lower substrate. However, since intrinsic fluorescence is not generated just by such an ID recording, another optical path (for example, an optical path that is not a fluorescence optical system) must be provided in the detection optical system. Such an additional process results in a disadvantage that the detection optical system becomes very expensive.

On the other hand, in the microchip according to the embodiment of the present application, it is possible to minimize the ID area in the case of recording an ID in the adhesion layer, and thereby, it is possible to decrease the scanning range of the detection optical system and decrease the size of the chip.

In the microchip according to the embodiment of the present application, the chip information and/or the assay information are recorded as the optical information (signals), in the adhesion layer area near the well or flow passage in the chip by utilizing the presence or absence of the adhesion layer and the amount of the adhesion layer. Since the microchip according to the embodiment of the present application employs such a method, the chip in which the chip information and the assay information are recorded can be produced at low costs, compared to a method in which the bar code is attached additionally.

In the present application, the ID area 33 containing the chip information and the assay information can be easily read by a traditional measuring method with the detection optical system. Thereby, it is not necessary to provide another reading device in the optical measuring apparatus, and therefore, it is possible to produce the apparatus at a small size and at low costs. Furthermore, it is unnecessary for an operator to input an assay method, and therefore, it is possible to accurately perform a biochemical treatment.

Thus, in accordance with the present application, in a microchip having a configuration in which a plurality of substrates are laminated, it is possible to provide an optical measuring microchip in which chip information are stored as an ID area using the presence or absence of an adhesion layer between the substrates and the amount of the adhesion layer. The provision of the ID area allows a chip with chip information to be produced at low costs. Furthermore, it is possible to remove or decrease an effort for an operator to input assay information to the optical measuring apparatus. Also, it is possible to decrease incorrect inputs by an operator. Therefore, it is possible to perform an accurate measurement.

In related art, in a system in which plural types of assay differing in biochemical treatment are performed with a single optical measuring apparatus, chips are the same in appearance, but differ in spotted substance and assay using it.

Thereby, it is desirable to set chip treatment conditions such as temperature and the number of temperature cycles for each chip depending on the type of the chip, and in the actual situation, an operator inputs them.

A discriminator for discriminating the type of the chip, such as a bar code, may be provided to the outer circumference of the chip, however, actually, an attachment of a discriminator such as a bar code to the chip results in an addition of a production step for the attachment and an increase in costs of chip production.

Furthermore, actually, a bar code or the like requires a bar-cord reader corresponding to it, resulting in a complication of the apparatus and an increase in costs.

However, as the present application, by using a layer portion of an adhesive used for a substrate adhesion as a portion for the ID area, these problems can be solved. Furthermore, there is an advantage that the ID area is simply provided, and also a formation of such an adhesion layer gives an advantage in terms of production cost.

That is, the optical measuring microchip according to the embodiment of the present application and the control method therewith have beneficial effects compared to microchips in related art.

Here, preferably, the “chemical reaction” performed with the microchip according to the embodiment of the present application is a chemical reaction that allows for chemical and/or biological analyses.

In this chemical reaction, every substance, such as a chemical substance (a biologically active substance and the like), a protein, a peptide, a DNA, an RNA, an oligonucleotide, a polynucleotide, an antigen, an antibody, a microbe, a virus, a hormone, and their fragments, can be a measuring object. Preferably, the measuring specimen is a specimen relevant to an organism, such as a cell, a culture, amplified nucleic acids, a tissue, a body fluid, a urine, a serum and a biopsy tissue sample.

As the “chemical reaction,” it is allowable to use known chemical reaction methods that can detect a measuring object by reaction. Examples of the “chemical reaction” include nucleic acid amplification reaction, hybridization reaction between complementary nucleic acids, PCR elongation reaction, and antigen-antibody reaction. Examples of a labeling method in the chemical reaction include, but are not limited to, a labeling method using one or more selected from a fluorescent substance, a radioactive substance, an enzyme, and the like.

Examples of the “nucleic acid amplification reaction” include a traditional polymerase chain reaction (PCR) method by temperature cycle, and various isothermal amplification methods unaccompanied by temperature cycle. Examples of the isothermal amplification method include a loop-mediated isothermal amplification (LAMP) method, a smart amplification process (SMAP) method, a nucleic acid sequence-based amplification (NASBA) method, an isothermal and chimeric primer-initiated amplification of nucleic acids (ICAN) method (R), a transcription-reverse transcription concerted (TRC) method, a strand displacement amplification (SDA) method, a transcription-mediated amplification (TMA) method, and a rolling circle amplification (RCA) method. In addition to them, the “nucleic acid amplification reaction” widely encompasses poikilothermal and isothermal nucleic acid amplification reactions intended for nucleic acid amplification. These nucleic acid amplification reactions encompass reactions accompanied by quantitative determination of amplified nucleic acids, such as a real-time PCR method.

Thus, the optical measuring apparatus 1 according to the embodiment of the present application provides good detection accuracy.

Subsequently, an example of a case where the optical measuring apparatus according to the embodiment of the present application is used as a fluorescence detection apparatus will be described.

In a fluorescence detection apparatus according to the embodiment of the present application, for a detection of the fluorescence from the well or flow passage in the microchip, fluorescent calibration substances are respectively contained in the plurality of calibration areas whose distances from the detection optical system are the same as the well or flow passage. By compensating the signal quantity from the well or flow passage using the signal quantities from these fluorescent calibration substances, it is possible to improve the determination accuracy for detected fluorescence, even if a distance between the chip and the detection optical system changes, or even if the property of the detection optical system changes.

In related art, for an estimation of the quantity of DNA in the well or flow passage in the chip, a fluorescent reagent to bind DNA, such as molecular beacon, is used. When the well or flow passage is irradiated with excitation light for the fluorescent reagent, fluorescence is radiated from the well or flow passage. The quantity of DNA in the well or flow passage is associated with the quantity of the fluorescence. Therefore, by detecting the fluorescence quantity with the detection optical system, it is possible to estimate the quantity of DNA in the well or flow passage.

However, in fact, mechanical properties change, for example, the position of the well or flow passage in the chip, or the distance between the detection optical system and the chip varies for each chip. Thereby, in some cases, even if the quantities of DNA are the same, the signal quantities detected by the detection optical system are different. In such cases, there is a possibility that the quantity of DNA is incorrectly estimated. In particular, in a system that judges whether a sample contains a gene (positive) or does not contain it (negative), based on a certain quantity of the DNA, there has been a problem in that the variability of the mechanical accuracy causes the variability of the signal quantity of fluorescence, resulting in an incorrect determination.

However, such a problem can be solved by using the microchip according to the embodiment of the present application and the control method therewith.

Additionally, the present application may also be configured as (1) to (19) below.
(1) An opticalm measuring apparatus including:

a control unit that compensates detection light generated from a reaction area in a microchip, based on optical information from a detection-light-quantity calibration area.
(2) The optical measuring apparatus according to (1), wherein the detection-light-quantity calibration area is provided at an exterior and/or an interior of the microchip.
(3) The optical measuring apparatus according to (1) or (2), wherein the optical measuring apparatus compensates the detection light, based on a first distance between the detection-light-quantity calibration area and a detection optical system and a second distance between the reaction area and the detection optical system, the first distance being based on the optical information.
(4) The optical measuring apparatus according to any one of (1) to (3), wherein the optical measuring apparatus further compensates the detection light, based on a planar distance between the detection-light-quantity calibration area and the reaction area.
(5) The optical measuring apparatus according to any one of (1) to (4), wherein a plurality of the detection-light-quantity calibration areas are provided in a stair-like manner, and the optical measuring apparatus compensates the detection light generated from the reaction area in the microchip, based on a plurality of pieces of the optical information from the detection-light-quantity calibration areas.
(6) The optical measuring apparatus according to any one of (1) to (4), wherein the detection-light-quantity calibration area contains a detection-light-quantity calibration substance that is in a solid form, semisolid form, or liquid form.
(7) The optical measuring apparatus according to (6), wherein the detection-light-quantity calibration substance is an inorganic substance and/or organic substance emitting a desired light component and light quantity.
(8) The optical measuring apparatus according to any one of (1) to (7), wherein an adhesion layer having an ID area is formed in the detection-light-quantity calibration area.
(9) The optical measuring apparatus according to (8), wherein the ID area contains detection-light-quantity calibration information.
(10) The optical measuring apparatus according to (8) or (9), wherein the ID area further contains assay information and/or chip information.
(11) The optical measuring apparatus according to any one of (8) to (10), wherein the ID area is an area in which a discrimination pattern is formed by a thickness of the adhesion layer.
(12) The optical measuring apparatus according to any one of (1) to (11), further including:

a movable detection optical system that acquires the optical information,

wherein, based on the optical information transmitted from the movable detection optical system, the control unit determines a state of the movable detection optical system, by comparing a signal quantity estimated from the optical information from a plurality of the detection-light-quantity calibration areas and a signal quantity calculated from the acquired optical information.
(13) The optical measuring apparatus according to (12), wherein the optical measuring apparatus further compensates the detection light, based on a relation of a first distance between the detection-light-quantity calibration area and the detection optical system with a second distance between the reaction area and the detection optical system, and a relation with a planar distance between the detection-light-quantity calibration area and the reaction area, the first distance being based on the optical information.
(14) The optical measuring apparatus according to any one of (1) to (13), wherein the plurality of detection-light-quantity calibration areas are provided in a stair-like manner, and the optical measuring apparatus compensates the detection light generated from the reaction area in the microchip, based on a plurality of pieces of the optical information from the detection-light-quantity calibration areas.
(15) An optical measuring microchip including:

an adhesion layer having an ID area.
(16) The optical measuring microchip according to (15), wherein the ID area contains assay information and/or chip information.
(17) The optical measuring microchip according to (15) or (16), wherein the ID area is an area in which a discrimination pattern is formed by a thickness of the adhesion layer.
(18) The optical measuring microchip according to any one of (15) to (17), wherein a plurality of detection-light-quantity calibration areas for compensating detection light are provided as the assay information in the adhesion layer having the ID area, the detection light being generated from a reaction area serving as a reaction field.
(19) The optical measuring microchip according to any one of (15) to (18), wherein the optical measuring microchip is a microchip for nucleic acid amplification reaction.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical measuring apparatus comprising:
a control unit that compensates detection light generated from a reaction area in a microchip, based on optical information from a detection-light-quantity calibration area.

2. The optical measuring apparatus according to claim 1, wherein the detection-light-quantity calibration area is provided at an exterior and/or an interior of the microchip.

3. The optical measuring apparatus according to claim 2, wherein the optical measuring apparatus compensates the detection light, based on a first distance between the detection-light-quantity calibration area and a detection optical system and a second distance between the reaction area and the detection optical system, the first distance being based on the optical information.

4. The optical measuring apparatus according to claim 3, wherein the optical measuring apparatus further compensates the detection light, based on a planar distance between the detection-light-quantity calibration area and the reaction area.

5. The optical measuring apparatus according to claim 2, wherein a plurality of the detection-light-quantity calibration areas are provided in a stair-like manner, and the optical measuring apparatus compensates the detection light generated from the reaction area in the microchip, based on a plurality of pieces of the optical information from the detection-light-quantity calibration areas.

6. The optical measuring apparatus according to claim 3, wherein the detection-light-quantity calibration area contains a detection-light-quantity calibration substance that is in a solid form, semisolid form, or liquid form.

7. The optical measuring apparatus according to claim 6, wherein the detection-light-quantity calibration substance is an inorganic substance and/or organic substance emitting a desired light component and light quantity.

8. The optical measuring apparatus according to claim 1, wherein an adhesion layer having an ID area is formed in the detection-light-quantity calibration area.

9. The optical measuring apparatus according to claim 8, wherein the ID area contains detection-light-quantity calibration information.

10. The optical measuring apparatus according to claim 9, wherein the ID area further contains assay information and/or chip information.

11. The optical measuring apparatus according to claim 10, wherein the ID area is an area in which a discrimination pattern is formed by a thickness of the adhesion layer.

12. The optical measuring apparatus according to claim 1, further comprising:
a movable detection optical system that acquires the optical information,
wherein, based on the optical information transmitted from the movable detection optical system, the control unit determines a state of the movable detection optical system, by comparing a signal quantity estimated from the optical information from a plurality of the detection-light-quantity calibration areas and a signal quantity calculated from the acquired optical information.

13. The optical measuring apparatus according to claim 12, wherein the optical measuring apparatus further compensates the detection light, based on a relation of a first distance between the detection-light-quantity calibration area and the detection optical system with a second distance between the reaction area and the detection optical system, and a relation with a planar distance between the detection-light-quantity calibration area and the reaction area, the first distance being based on the optical information.

14. The optical measuring apparatus according to claim 13, wherein the plurality of detection-light-quantity calibration areas are provided sterically, and the optical measuring apparatus compensates the detection light generated from the reaction area in the microchip, based on a plurality of pieces of the optical information from the detection-light-quantity calibration areas.

15. An optical measuring microchip comprising:
an adhesion layer having an ID area.

16. The optical measuring microchip according to claim 15, wherein the ID area contains assay information and/or chip information.

17. The optical measuring microchip according to claim 16, wherein the ID area is an area in which a discrimination pattern is formed by a thickness of the adhesion layer.

18. The optical measuring microchip according to claim 17, wherein a plurality of detection-light-quantity calibration areas for compensating detection light are provided as the assay information in the adhesion layer having the ID area, the detection light being generated from a reaction area serving as a reaction field.

19. The optical measuring microchip according to claim 15, wherein the optical measuring microchip is a microchip for nucleic acid amplification reaction.
